(19) United States
(12) Patent Application Publication
(10) Pub. No.: US 2023/0003874 A1
(43) Pub. Date: Jan. 5, 2023

(54) PEDAL WITH ANTI-COLLISION DETECTION AND RADAR INSTALLATION SPACE

(71) Applicant: CUB ELECPARTS INC., Changhua County (TW)

(72) Inventors: SAN-CHUAN YU, Changhua County (TW); SAN-YENG YANG, Changhua County (TW); CHENG-HSIN LI, Changhua County (TW); TE-YU LU, Changhua County (TW); PO-CHUN CHANG, Changhua County (TW); CHUN-LIANG CHEN, Changhua County (TW)

(73) Assignee: CUB ELECPARTS INC., Changhua County (TW)

(21) Appl. No.: 17/578,579

(22) Filed: Jan. 19, 2022

(30) Foreign Application Priority Data
Jul. 5, 2021 (TW) 110124661

(51) Int. Cl. G01S 13/931; G01S 13/62; G01S 7/02

(52) U.S. Cl. CPC G01S 13/931; G01S 13/62; G01S 7/027; B60R 3/007

(57) ABSTRACT

A pedal with anti-collision detection is installed on the rear of a vehicle. The pedal includes a pedal body and a radar device, with an insertion portion extending from the rear lateral side of the pedal body. Arc ribs are arranged from a rear lateral side of the pedal body toward a front lateral side of the pedal body at intervals, and straight ribs extend from the rear lateral side toward the front lateral side in a radial arrangement. The arc ribs and the straight ribs are interlaced, forming reinforcement spaces therebetween. An installation space is formed on an inner side of the front lateral side toward the rear lateral side for receiving the radar device. Each reinforcement space contains a reinforcement structure, thereby strengthening the structural strength of the pedal for protecting the radar device.

### BACKGROUND OF THE INVENTION

### 1. Field of the Invention

The present invention relates to a pedal with anti-collision detection and radar installation space. The pedal is installed on the rear of the vehicle for facilitating blind spot detection and reversing detection functions.

### 2. Description of the Related Art

Pickup trucks are one of currently popular kinds of vehicles, which can be applied for towing a camper van or jet ski, facilitating traveling or outdoor activities.

Based on the fact that this kind of vehicle will usually be applied for towing aforementioned objects or provided with anti-collision bumper, systems of blind spot detection (BSD) or reversing detection cannot be installed on the rear of the truck for preventing collision accidents. When such vehicle is not applied for towing objects, a pedal is usually installed on the rear thereof for facilitating the entering or leaving of passengers. Such pedal has a relatively limited area. Also, for bearing the weight of the passenger stepping thereon for entering or leaving the vehicle, the pedal must be provided with a certain degree of structural strength and weight bearing capability.

### SUMMARY OF THE INVENTION

To facilitate an anti-collision detection when the vehicle is not towing objects, the present invention discloses a pedal with anti-collision detection and radar installation space. Also, the pedal, after being installed with anti-collision detection device, still has high structural strength and weight bearing capability.

For achieving the aforementioned objectives, the present invention provides a pedal with anti-collision detection function. The pedal is installed on the rear of a vehicle and comprises a pedal body and a radar device; the pedal body comprises a front lateral side and a rear lateral side that are spaced and arranged along a longitudinal axis of the pedal body, wherein the front lateral side and the rear lateral side are not disposed on the same planes, with a pedaling face connected between the front lateral side and the rear lateral side; a first connection face and a second connection face extend from two sides of the pedaling face to be connected between the front lateral side and the rear lateral side, so as to form a recess on the pedal body; an insertion segment extends from the rear lateral side; in the recess of the pedal body, a plurality of arc ribs are arranged from the rear lateral side toward the front lateral side at intervals, and a plurality of straight ribs extend from the rear lateral side toward the front lateral side; an installation space is formed on an inner side of the front lateral side toward the rear lateral side; a plurality of reinforcement spaces are disposed between the arc ribs and the straight ribs in adjacent to the installation space, wherein each reinforcement space contains a reinforcement structure; and a radar device is disposed in the installation space.

For achieving the aforementioned objectives, the present invention provides a pedal with a radar installation space. The pedal is installed on the rear of a vehicle and comprises a pedal body; the pedal body comprises a front lateral side and a rear lateral side that are spaced and arranged along a longitudinal axis of the pedal body, wherein the front lateral side and the rear lateral side are not disposed on the same planes, with a pedaling face connected between the front lateral side and the rear lateral side; a first connection face and a second connection face extend from two sides of the pedaling face to be connected between the front lateral side and the rear lateral side, so as to form a recess on the pedal body; an insertion segment extends from the rear lateral side; in the recess of the pedal body, a plurality of arc ribs are arranged from the rear lateral side toward the front lateral side at intervals, and a plurality of straight ribs extend in a radiation arrangement from the rear lateral side toward the front lateral side; an installation space is formed on an inner side of the front lateral side toward the rear lateral side; a plurality of reinforcement spaces are disposed between the arc ribs and the straight ribs, wherein each reinforcement space contains a reinforcement structure.

With such configuration, the pedal body of the present invention applies a plurality of interlaced straight ribs and arc ribs, with the reinforcement spaces containing reinforcement structures therebetween, thereby increasing the structural strength of the pedal body, achieving an optimal weight bearing capability, forming the installation space for receiving the radar device, and providing protection to the radar device in the installation space to ensure the effect operation of the radar device.

Also, the pedal of the present invention is installed on the rear of the vehicle, providing the blind spot detection and reversing detection functions to the vehicle, achieving a warning function when the vehicle moves forward or backward for preventing collision accidents.

### BRIEF DESCRIPTION OF THE DRAWINGS

The patent or application file contains at least one color drawing. Copies of this patent or patent application publication with color drawing will be provided by the USPTO upon request and payment of the necessary fee.

FIG. 1 is a perspective view of the pedal body with anti-collision detection function in accordance with an embodiment of the present invention.

FIG. 2 is another perspective view of the pedal body with anti-collision detection function in accordance with an embodiment of the present invention taken from another viewpoint.

FIG. 3 is a schematic view of the bottom face of the pedal with anti-collision detection function in accordance with an embodiment of the present invention.

FIG. 4 is a schematic view illustrating the wiring structure of the pedal.

FIG. 5 is another schematic view illustrating the wiring structure of the pedal.

FIG. 6a is a Von Mises stress distribution diagram of the pedal of the present invention.

FIG. 6b is a Von Mises stress distribution diagram of the pedal of a prior art.

FIG. 7 is a block diagram of the radar device of the pedal in accordance with an embodiment of the present invention.

FIG. 8 is a schematic view illustrating the signal processing operation of the radar device of the pedal in accordance with an embodiment of the present invention.

FIG. 9 is a schematic view illustrating the detection carried out by the present invention toward objects in the rear detection area of a moving vehicle.

FIG. 10 is a modal value distribution diagram of the relative velocity and reflection points after the detection of objects in the rear detection area of the moving vehicle in FIG. 9.

FIG. 11 is a modal value distribution diagram of N sets of relative velocity and reflection points of the detection carried out along a time window.

FIG. 12 is a curve diagram of the variation of a speed average value made according to the modal value distribution diagram of FIG. 11.

FIG. 13 is a schematic view illustrating the path prediction carried out the by radar device.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion, size, variation or movement amount suitable for explanation but not subject to the actual component proportion.

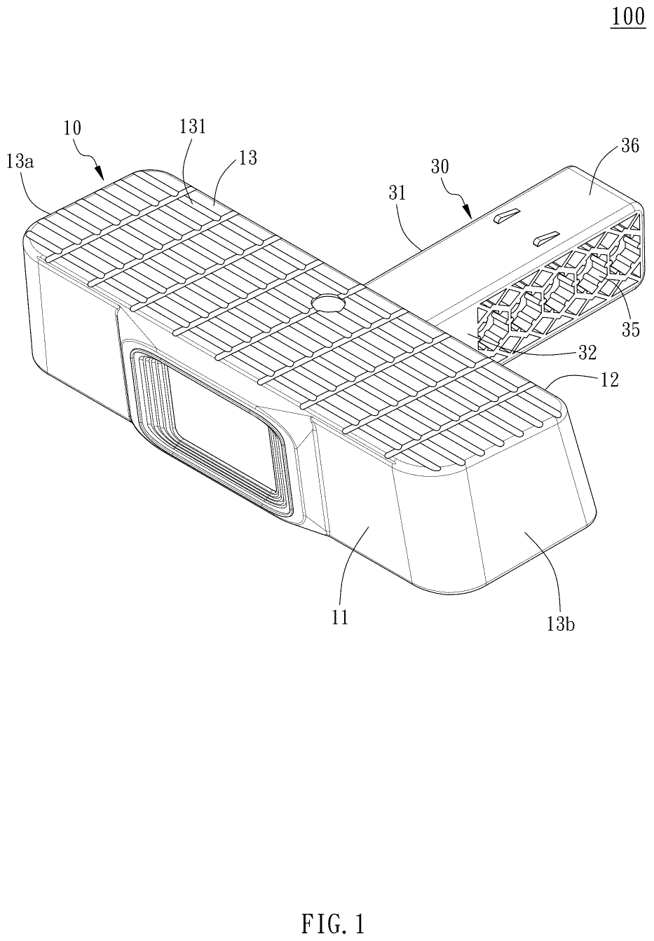

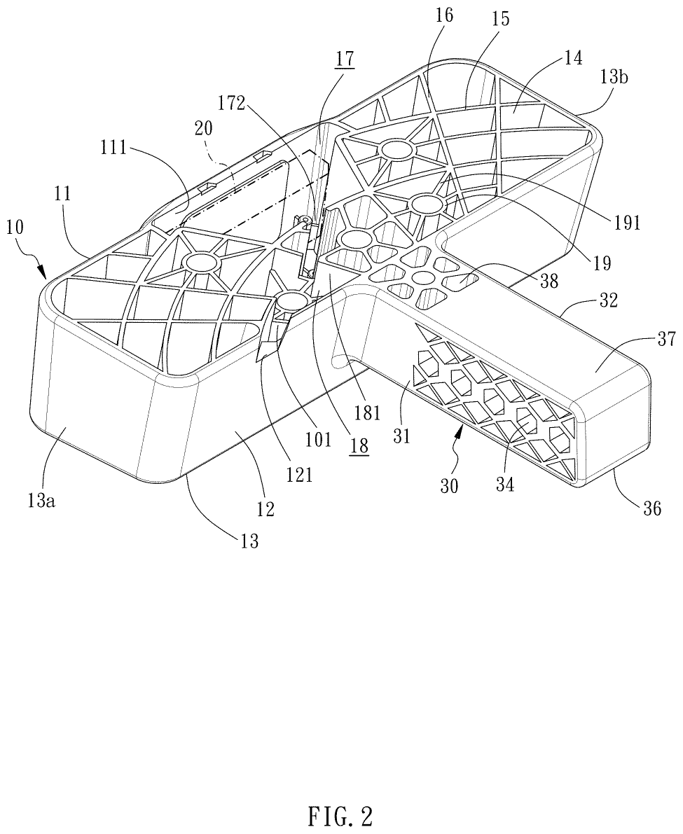

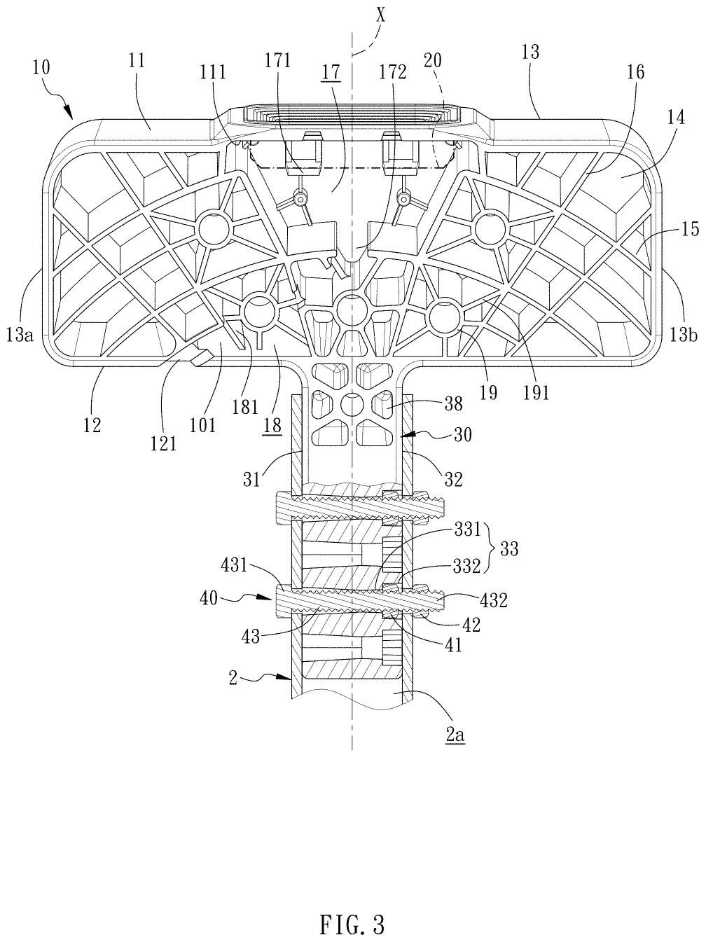

Referring to FIG. 1 to FIG. 4, the present invention provides a pedal 100 with anti-collision function, which is installed on the rear of a vehicle 1. The pedal 100 comprises a pedal body 10 and an insertion segment 30 extending from the pedal body 10, wherein the pedal body 10 comprises a radar device 20 disposed therein. The vehicle 1 is allowed to be, for example but not limited to, a pickup truck, freight truck, or station wagon. The radar device 20 provides blind spot detection and reversing detection functions, so as to achieve a warning function when the vehicle 1 is moving forward or backward, thereby preventing collision accidents.

The pedal body 10 comprises a front lateral side 11 and a rear lateral side 12 that are spaced with each other and arranged along a longitudinal axis X, wherein the front lateral side 11 and the rear lateral side 12 are not disposed on the same plane, and a pedaling face 13 is connected between the front lateral side 11 and the rear lateral side 12. The pedaling face 13 comprises a plurality of non-slip grooves 131, such that a person steps on the pedaling face 13 when entering or leaving the vehicle 1, and the non-slip grooves 131 provide anti-slip and water draining affects. Therein, the pedaling face 13 is the top side of the pedal body 10. A first connection face 13a and a second connection face 13b extend from two sides of the pedaling face 13, wherein the first connection face 13a and the second connection face 13b are connected between the front lateral side 11 and the rear lateral face 12, so as to form a recess 14 of the pedal body 10. Therefore, the recess 14 is formed by an enclosure of the front lateral side 11, rear lateral side 12, pedaling face 13, the first connection face 13a, and the second connection face 13b. In the embodiment, the insertion segment 30 extend from the rear lateral side 12 along the longitudinal axis X. The recess 14 is structurally favorable for lowering the weight and saving the forming material of the pedal body 10.

In the recess 14 of the pedal body 10, a plurality of arc ribs 15 are disposed from the rear lateral side 12 toward the front lateral side 11 at intervals, and a plurality of straight ribs 16 extend from the rear lateral side 12 toward the front lateral side 11 in a radiation arrangement. The pedal body 10 comprises an installation space 12 on an inner side of the front lateral side 11 toward the rear lateral side 12 for receiving the radar device 20. Also, the arc ribs 15 and the straight ribs 16 extend toward the direction away from the pedaling face 13 to be interlaced. In a preferred embodiment, the arc ribs 15 and the straight ribs 16 are connected on an inner side of the pedaling face 13. Also, a plurality of reinforcement spaces 18 are formed between the arc ribs 15 and the straight ribs 16, and the reinforcement spaces 18 are arranged in adjacent to the installation space 17. Additionally, each reinforcement space 18 contains a reinforcement structure. Therefore, the reinforcement structures, arc ribs 15 and the straight ribs 16 enable the pedal body 10 to bear a momentary force when people are entering or leaving the vehicle 1 by it, achieving a structural strengthening function. Therein, the installation space 17 contains a pair of vertically formed block portions 171. The radar device 20 is stably disposed and positioned in the place between the two block portions 171 and the inner lateral 111 on a back of the front lateral side 11, such that the radar device 20 is prevented from wavering in the installation space 17.

In the embodiment, each reinforcement space 18 comprises an inner wall 181. Each reinforcement structure comprises a reinforcement pillar 19 in a hollow column shape, and a plurality of connection ribs 191 arranged in a radiation arrangement connected between the reinforcement pillar 19 and the inner wall 181. Also, each reinforcement pillar 19 and the connection ribs 191 extend toward the pedaling face 13 to be connected with the inner side of the pedaling face 13, such that the reinforcement pillar 19 is vertically disposed, and arranged in approximate parallel to the stepping force direction of people stepping on the pedal body 10 for directly bearing the stepping force and increasing the weight bearing capability of the pedal body 10. Also, the connection ribs 191 are disposed on the periphery of the reinforcement pillar 19 for providing the supporting force to the periphery of each reinforcement pillar 19, thereby increasing the structural strength of the pedal body 10. In another embodiment, the reinforcement structure can also comprise only one reinforcement pillar 19 disposed in the reinforcement space 18 and connected with the inner wall 181. In another embodiment, the reinforcement structure can be formed by a plurality of reinforcement pillars 19 that are connected in parallel. In another embodiment, the reinforcement pillar 19 can also be formed in a non-circular shape, such as a rectangular or polygonal shape, so that a plurality of reinforcement pillars 19 together form a beehive alike structure, which provides a structurally strengthening effect as well.

Also, in the embodiment, the installation space 17 corresponds to at least three reinforcement spaces 18, and each reinforcement space 18 contains six connection ribs 191 therein. The installation space 17 and at least one reinforcement space 18 are arranged on the longitudinal axis X, with two reinforcement spaces 18 arranged on both sides of the longitudinal axis X, respectively. In the embodiment, five reinforcement spaces 18 are included and disposed in a V shape arrangement in adjacent to the installation space 17, wherein the installation space 17 has one side facing the outer side of the pedal body 10, with other three sides corresponding to the reinforcement spaces 18, so that the installation space 17 is surrounded by larger amount of reinforcement spaces 18, thereby providing a higher structural protection to the radar device 20 disposed in the installation space 17. The connection ribs 191 and the corresponding reinforcement pillar 19 forms a radiation structure similar to the shape of the sun, thereby increasing the weight bearing capability of the pedal body 10 and providing protection to the radar device 20 disposed in the installation space 17 of the pedal body 10. Thus, after a frequent usage, the pedal 100 can still be protected from structural damage, and the service life of the radar device 20 is kept from detrimental effect.

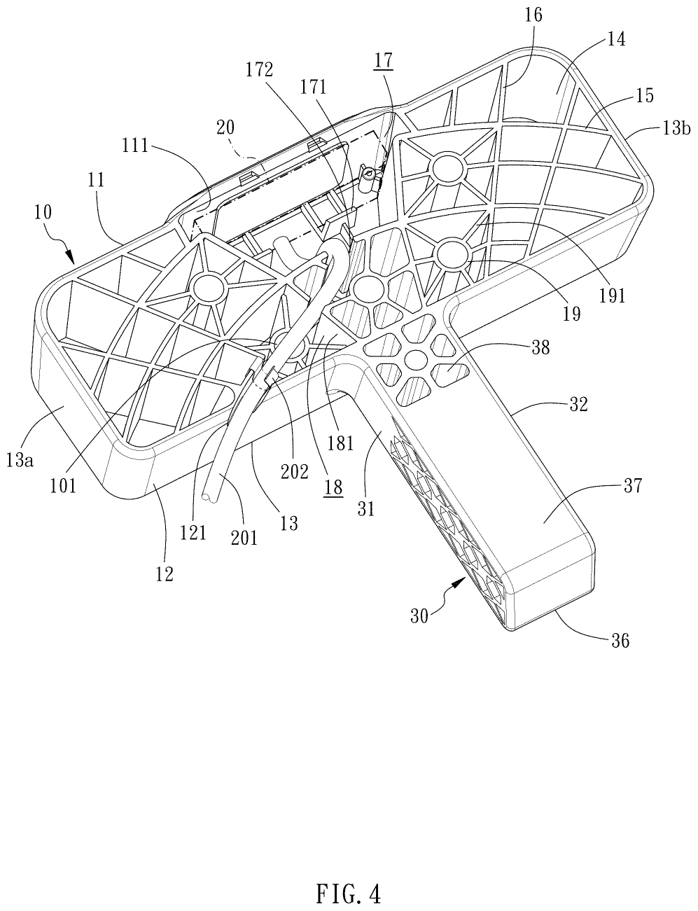

Referring to FIG. 4, in another embodiment, the pedal body 10 comprises a wire recess 101 in communication with the installation space 17, facilitating the electrical connection of a wire 201 between the radar device 20 and the computer of the vehicle. The installation space 17 comprises a first opening 172, and the rear lateral side 12 comprises a second opening 121, wherein the wire recess 101 passes through one reinforcement space 18, such that the wire recess 101 has one end connected to the first opening 172 and the other end connected to the second opening 121. For preventing the wire 201 from suspending, the embodiment further comprises a spring clamp 202 applied for clamping the wire 201 on the arc rib 15 or straight rib 16, thereby preventing the wire 201 from breaking and wearing. Notably, to shorten the wiring path of the wire 201, the height of the reinforcement pillar 19 and the corresponding connection ribs 191 in the reinforcement space 18 through which the wire 201 passes is smaller than the height of the reinforcement pillar 19 and the corresponding connection ribs 191 in other reinforcement spaces 18, so as to provide an allowance space for the wire 201 to be wired between the first opening 172 and the second opening 121 along a shorter path. Therein, in the embodiment, the first opening 172 and the second opening 121 are placed closed to one side of the pedal body 10 away from the pedaling face 13.

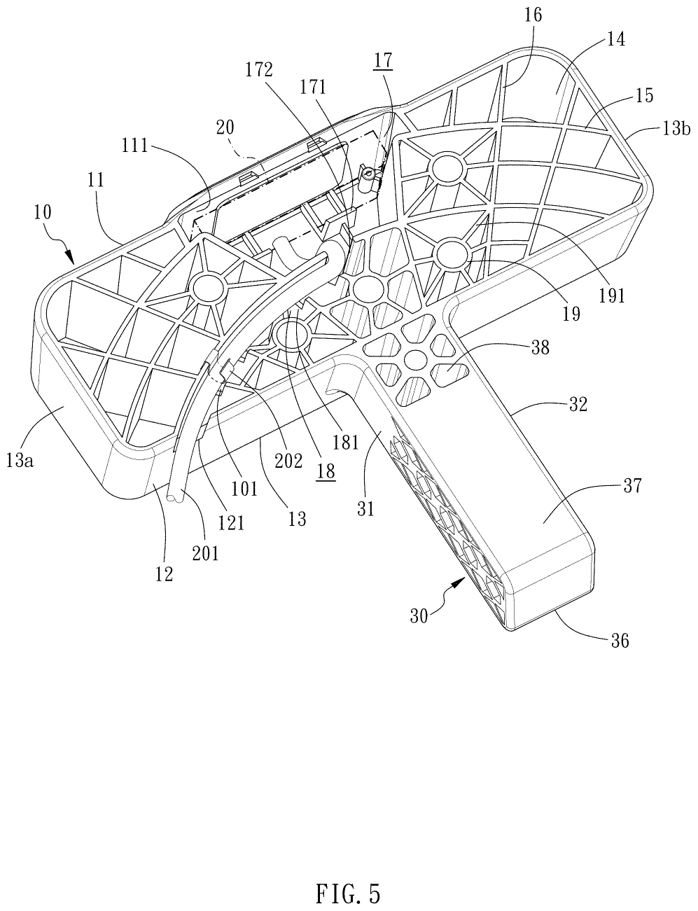

Referring to FIG. 5, in another embodiment, the wire recess 101 can be configured to pass through one of the reinforcement spaces 18 and connected between the first opening 172 and the second opening 121 along one of the arc ribs 15, such that the spring clamp 202 clamps the wire 201 on the corresponding arc rib 15 or straight rib 16. Such configuration will not affect the structure of the reinforcement pillar 19 and connection ribs 191 in the reinforcement space 18 through which the wire 201 passes. In other words, the height of the reinforcement pillar 19 will not be affected by the wiring and will not affect the structural strength.

The insertion segment 30 comprises a first outer lateral side 31 and a second outer lateral side 32 disposed on both sides of the longitudinal axis X. The insertion segment 30 is fastened to a slot 2a of a connector 2 of the vehicle 1 through a fasten assembly 40. A fasten portion 33 is disposed between the first outer lateral side 31 and the second outer lateral side 32, wherein the fasten portion 33 has a through hole 331 on one end, and a non-circular engagement groove 332 on the other end in communication with the through hole 331. Further, the insertion segment 30 comprises a first reinforcement rib area 34 on the first outer lateral side 31 toward the longitudinal axis X, and a second reinforcement rib area 35 on the second outer lateral side 32 toward the longitudinal axis X. The insertion segment 30 further comprises a top face 36 and a bottom face 37 connected between the first outer lateral side 31 and the second outer lateral side 32. A hollow reinforcement rib area 38 is disposed on the bottom face 37 toward the top face 36 in adjacent to the rear lateral side 12 of the pedal body 10. Therefore, the first reinforcement rib area 34, the second reinforcement rib area 35, and the hollow reinforcement rib area 38 together provides a weight reducing and a structural strengthening effects.

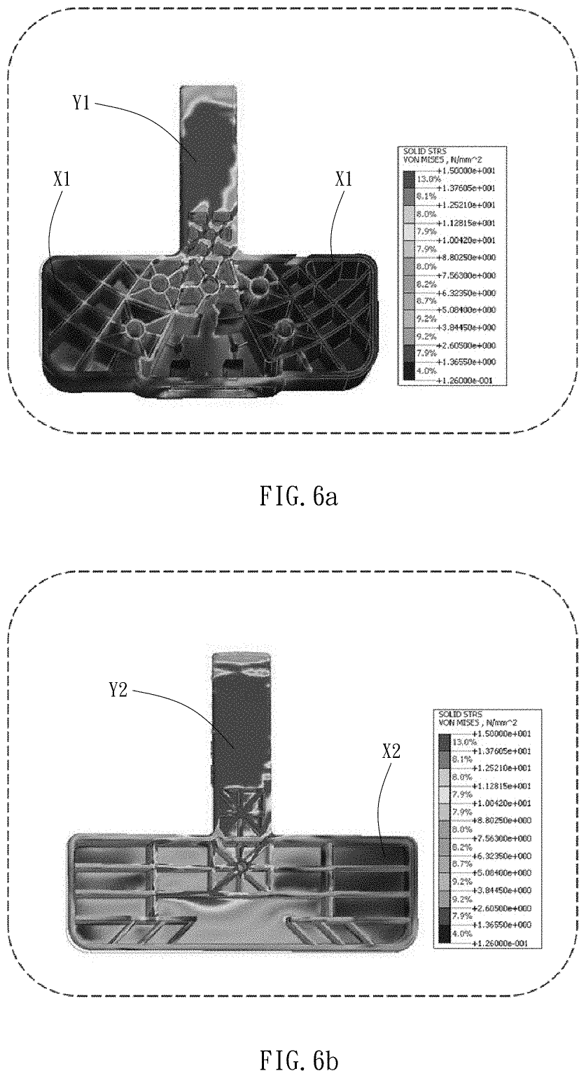

Referring to FIG. 6a and FIG. 6b, the Von Mises stress distribution diagrams of the pedal 100 of the present invention and the conventional pedal are illustrated, wherein the test force is set at 3001bf. The conventional pedal in FIG. 6b has an ordinary grid shaped structure. In FIG. 6a and FIG. 6b, X1 and X2 represent the smallest stress area (corresponding to a range from 1.26000e⁻⁰⁰¹ N/mm² 1.36550e⁰⁰⁰ N/mm²); Y1 and Y2 represent the largest stress area (corresponding to a range from 1.37605e⁰⁰¹ N/mm² to 1.50000e⁰⁰¹ N/mm²). As shown by FIG. 6a, the range of the largest stress area Y1 of the pedal 100 of the present invention is smaller than the range of the smallest stress area Y2 of the conventional pedal, and the range of the smallest stress area X1 of the pedal 100 of the present invention is larger than the range of the smallest stress area X2 of the conventional pedal. Also, the stress range of the conventional pedal corresponding to the range from 2.60500⁰⁰⁰ N/mm² to 1.25210e⁰⁰¹ N/mm² is larger than the stress range of the present invention corresponding to the range from 2.60500e⁰⁰⁰ N/mm² to 1.25210e⁰⁰¹ N/mm². Meanwhile, regarding the pedal 100 of the present invention, with the reinforcement spaces 18 that are disposed in a V shape arrangement in adjacent to the installation space 17, most of the stress range corresponding to the range from 2.60500e⁰⁰⁰ N/mm² to 1.25210e⁰⁰¹ N/mm² falls into the area of the location of the reinforcement spaces 18. Therefore, the strengthen structure is capable of bearing more stress to effectively increase the structural strength of the overall pedal 100. Thus, the pedal 100 of the present invention is structurally enhanced and has a better weight bearing capability over the conventional pedal.

The fasten assembly 40 comprises a first screw member 41, a second screw member 42, and a fastener 43. The first screw member 41 and the second screw member 42 are, for example, a nut, and the fastener 43 is, for example, a bolt. The first screw member 41 can be disposed in the non-circular engagement groove 332 and prevented from rotation with respect thereto. The fasten member 43 comprises a head portion 431 and a thread portion 432 extending from the head portion 431. The head portion 431 abuts against the first outer lateral side 31. The second screw member 42 abuts against the second outer lateral side 32. The thread portion 432 of the fasten member 43 passes through the through hole 331 of the fasten portion 33 to be fastened to the first screw member 41 and the second screw member 42, such that the pedal body 10 is fastened to the slot 2a of the connector 2. Therein, when the insertion segment 30 is screwedly fixed through the fasten assembly 40, the insertion segment 30 is stably clamped and positioned in the slot 2a by the screwing relationship between the first screw member 41, the second screw member 42, and the fasten member 43. Also, based on the fact that the first screw member 41 is prevented from rotation with respect to the non-circular engagement groove 332, the pedal body 10 is prevented from wavering with respect to the slot 2a, thereby ensuring the detection accuracy of the radar device 20. Therefore, the radar device 20 is prevented from detection error caused by possible wavering situation.

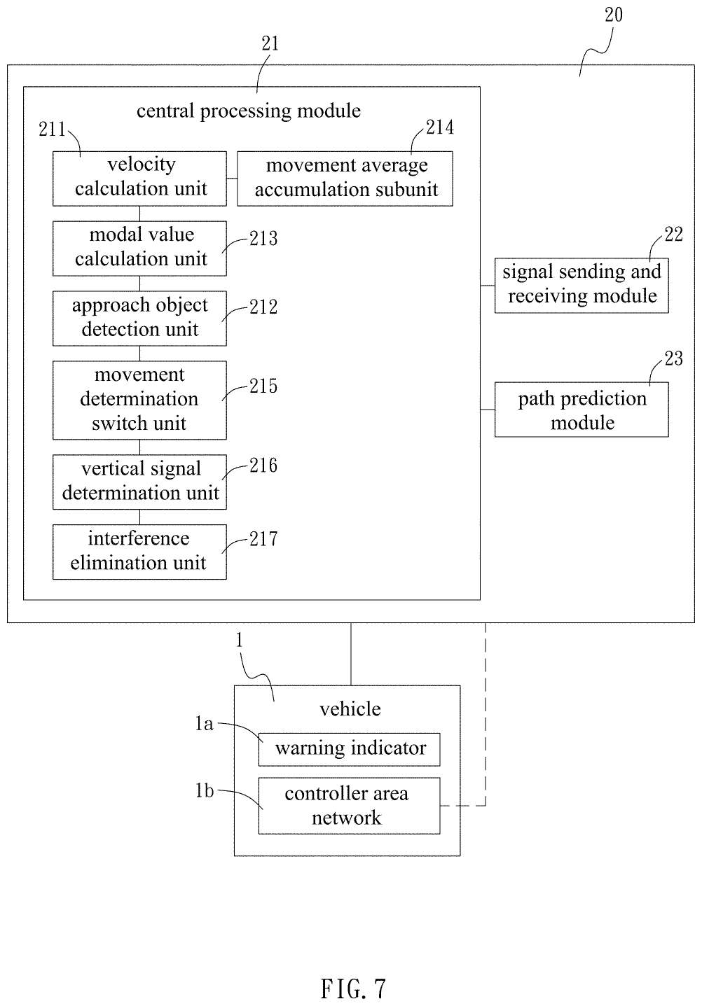

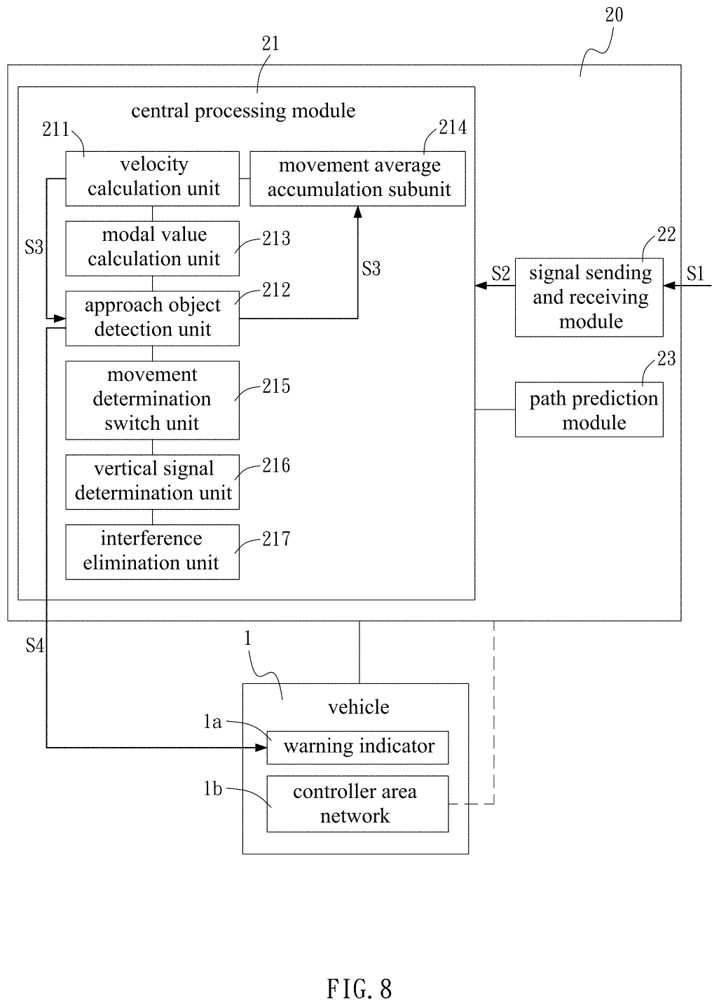

Referring to FIG. 7 to FIG. 9, the radar device 20 in the embodiment comprises a central processing module 21, and a signal sending and receiving module 22 and a path prediction module 23 that are electrically connected with the central processing module 21. The signal sending and receiving module 22 sends a first signal S1 toward a detection area Z in rear of the vehicle 1, so as to acquire a second signal S2 which is reflected by the object in the detection area Z. The radar device 20 carries out the blind spot detection according to the second signal S2.

In the embodiment, the signal sending and receiving module 22 is an application of an mmWave radar, wherein the detection frequency band is 77 GHz.

When the mmWave radar sends the first signal S1 at the frequency band of 77 GHz, the reflected second signal S2 generates about twenty to thirty reflection points in an 100 cm detection range, with an averagely reflection point existing in every 4 cm range. Compared with the detection band of 24 GHz which has only two reflection points in every 100 cm range in average, the present invention has a relatively higher resolution. Also, the detection frequency band is not limited to 77 GHz as described in the embodiment; the detection frequency band can be higher or lower than 77 GHz. After all, the difference of detection frequency band only brings out the difference of the resolution of the reflection points. Thus, different detection frequency bands corresponding to suitable resolution of reflection points without departing from the present invention fall into the claim range of the present invention.

The central processing module 21 is electrically connected with the signal sending and receiving module 22, so as to receive the second signal S2. The central processing module 21 comprises a velocity calculation unit 211 and an approaching object detection unit 212. Also in another embodiment, the central processing module 21 further comprises a modal value calculation unit 213 electrically connected with the velocity calculation unit 211. In addition, the velocity calculation unit 211 comprises a movement average accumulation subunit 214. The approaching object detection unit 212, according to the second signal S2 received, identifies the approaching object in the detection area Z for carrying out the blind spot detection operation, based on which the central processing module 21 determines the possibility of collision of the approaching object and the vehicle 1.

When the approaching object detection unit 212 carries out the blind spot detection according to the second signal S2, a warning indicator 1a disposed on the vehicle 1 generates a warning when there is an object approaching the vehicle 1 in the detection area Z. The warning indicator 1a, in the embodiment, comprises two warning lights disposed on the rear view mirrors on two sides of the vehicle 1, respectively (not shown). The warning indicator 1a can also be a buzzer (not shown) or a combination of the warning light and buzzer.

With the foregoing configuration, method of blind spot detection of the present invention will be illustrated below.

The signal sending and receiving module 22 (the aforementioned mmWave radar) sends the first signal S1 toward the detection area Z in rear of the vehicle, so as to acquire the second signal S2 reflected by the object in the detection area Z. The radar device 20 carries out the blind spot detection according to the second signal S2. The detection area Z is, for example in the embodiment, a 120-degree horizontal range in rear of the vehicle 1. In the embodiment, objects in the detection area Z include a vehicle A, a vehicle B, a vehicle C, and a ground surface G of the road on which the vehicle 1 is moving. The first signal S1 is reflected by the vehicle A, vehicle B, vehicle C, and ground surface G to be received as the second signal S2. At this time, the radar device 20 is able to carry out the blind spot detection through the second signal S2.

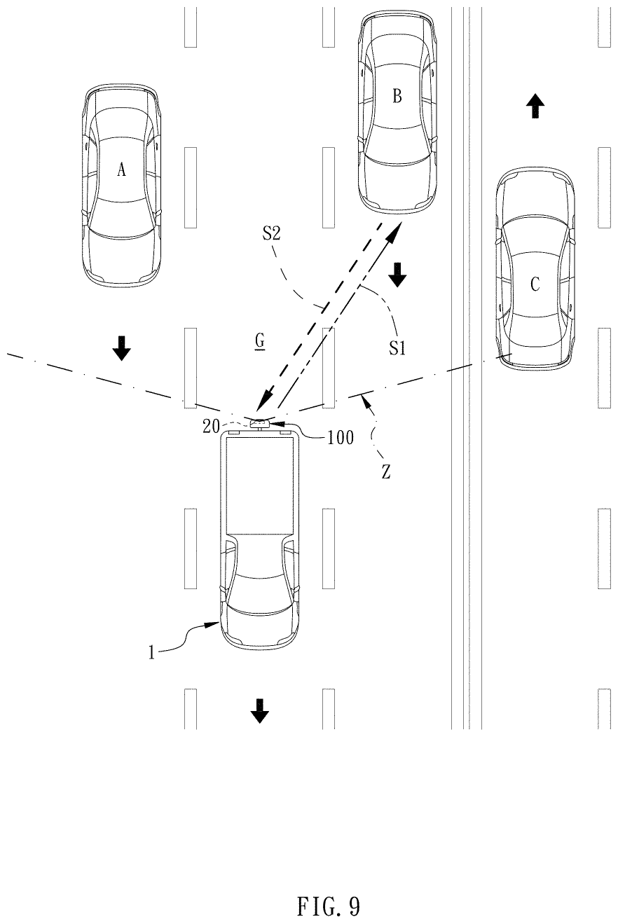

Then, the velocity calculation unit 211 calculates the relative velocity of the object in the detection area Z with respect to the vehicle 1, so as to generate a third signal S3, which is the relative velocity information of the object in the detection area Z with respect to the vehicle 1. For example, in FIG. 9, the vehicle 1 moves at 60 km/h on the road; the vehicle A and vehicle B move on at 30 km/h and 50 km/h on the road, respectively, in a direction identical with the moving direction of the vehicle 1; the vehicle C moves at 40 km/h on the road in a direction opposite to the moving direction of the vehicle 1. By calculation of the velocity calculation unit 211, the relative velocity of the vehicle with respect to the vehicle A is 30 km/h; the relative velocity of the vehicle with respect to the vehicle B is 10 km/h; the relative velocity of the vehicle with respect to the vehicle C is 100 km/h due to the opposite direction of movement; and the relative velocity of the vehicle with respect to the ground surface G is 60 km/h. Also, in the reflection points of the object in the detection area Z, the amount of the reflection points by the ground surface G is the most, so as to be considered as the modal value of the reflection points. When the modal values add up to reach a certain amount, the relative velocity corresponding to the modal value is outputted, and the information of this relative velocity is included in the third signal S3.

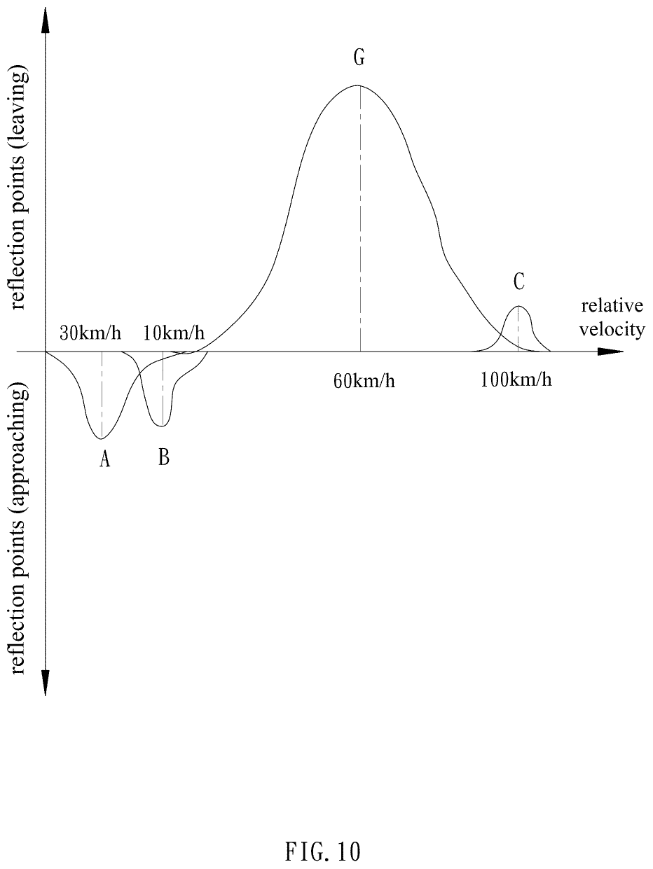

A further detailed description is shown in FIG. 10, which illustrates the distribution of the relative velocity of the vehicle 1 with respect to the ground surface G, the vehicle A, the vehicle B, and the vehicle C acquired by the modal value calculation unit 213 from the third signal S3. It is clear that the distribution of the reflection points of the relative velocity of 60 km/h covers the largest area, so as to be deemed as the modal value. When it reaches a certain amount, the modal value calculation unit 213 identifies the ground surface G as the static object, so that the relative velocity of the vehicle 1 with respect to the ground surface G is determined as the velocity of the vehicle 1 (60 km/h). Accordingly, based on the third signal S3, the objects in the detection area Z are identified as a static object or a moving object, whereby the relative velocity of the vehicle 1 with respect to the static object is determined as the velocity of the vehicle 1.

Notably, the wire 201 disposed in the wire recess 101 is applied for providing power from the vehicle and for the controller area network (CAN) 1b to provide the velocity signal of the vehicle 1 to the radar device 20, thereby achieving the blind spot detection or anti-collision detection functions. If the radar device 20 itself comprises said functions and is capable of detecting the velocity of the vehicle, the wiring of the wire 201 can be relatively simple for the purpose of providing the power. In such case, space of the wire recess 101 can be reduced for preventing the structural strength of the pedal body 10 from being lowered.

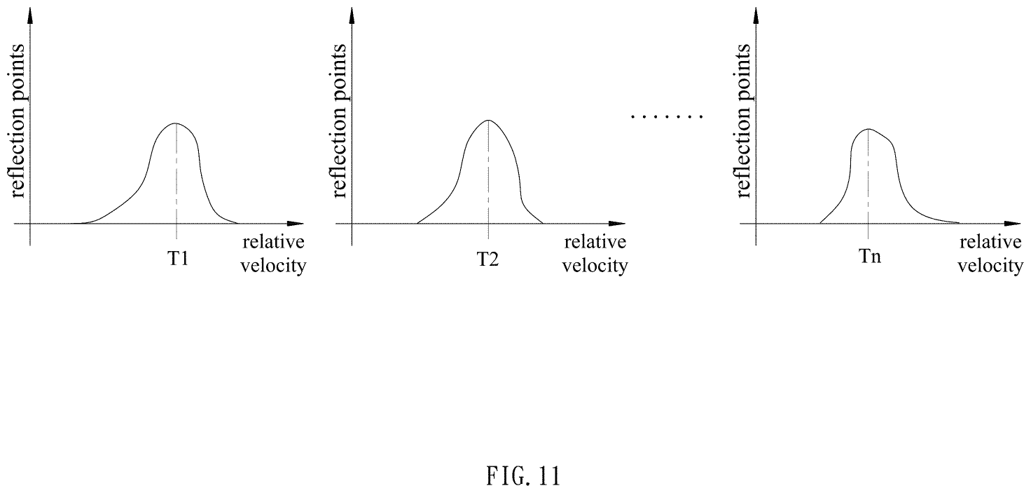

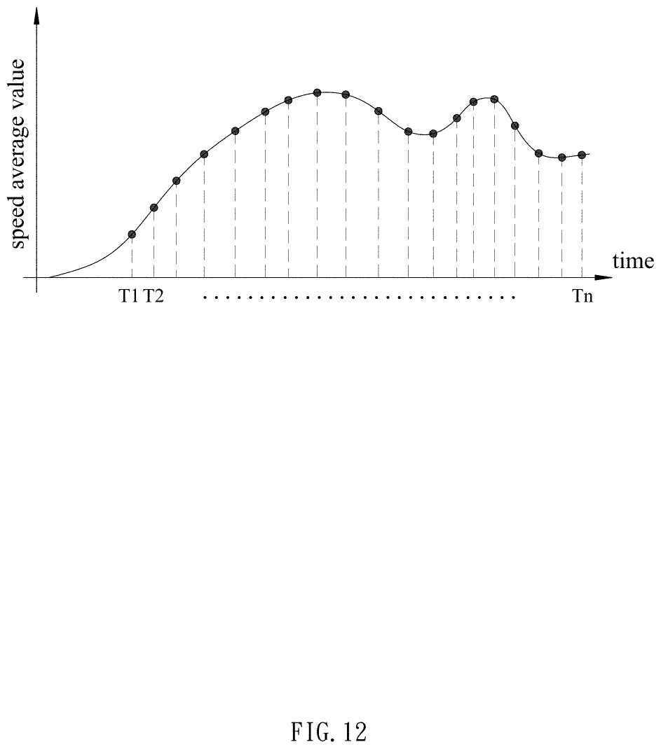

Also, referring to FIG. 7 to FIG. 12, a plurality of vehicle velocity are continuously sampled along the time window T during the movement of the vehicle, the movement average accumulation subunit 214 continuously carries out the movement average accumulation on the sampled vehicle velocity. The time window above is preferably between 0.05 to 0.3 seconds. In the embodiment, the time window T is set at 0.1 seconds, which means that the modal value calculation unit 23 calculates the modal value of the most amount of the relative velocity for confirming the static object at an interval of 0.1 seconds and determining the velocity of the vehicle 1 as the sampled velocity. Therefore, when the vehicle 1 moves for a period of time, N sets of sample vehicles are continuously acquired along the time window T each 0.1 seconds (as shown by FIG. 11). The movement average accumulation subunit 213 continuously carries out the movement average accumulation on the acquired N sets of sampled velocity, so as to acquire a curve of an average velocity which varies with time in the duration of the vehicle 1 movement (as shown by FIG. 12). The curve also represents the variation of the movement velocity of the vehicle 1.

In the embodiment, the movement average accumulation subunit 214 predetermines a velocity error. When the velocity difference of the sample velocity consecutively acquired in the time window T is greater than the velocity error, the later sampled velocity will not be included in the movement average accumulation. Preferably, the velocity error ranges from 1 km/h to 5 km/h. In the embodiment, the velocity error is 5 km/h. For example, the ground surface G is determined as the static object at a certain time window T, and the sampled velocity of the vehicle 1 is acquired as 60 km/h, and multiple vehicles approach the rear of the vehicle 1 quickly, and then keep moving at the velocity of 60 km/h to occupy most of the detection area Z. Currently, the relative velocity of the vehicle 1 with respect to the multiple vehicles behind is 0 km/h. With the determination of the modal value calculation unit 213, the multiple approaching vehicles are misrecognized as the modal value and deemed as the static object. The sampled velocity at the moment is 0 km/h. In the time window T of 0.1 seconds, the velocity difference between two sampled velocity obviously surpasses the predetermined velocity error of 5 km/h, so that the sampled velocity of 0 km/h will be excluded from the movement average accumulation, thereby preventing the velocity determination error.

In the embodiment, when a moving object in the detection area Z is identified as an approaching object, a warning signal S4 is generated to trigger the warning motion of the warning indicator 1a, wherein warning motion varies along with the shortening of the time to collision of the approaching object and the vehicle 1. In fact, the time to collision can be related to the operation period of the signal output (such as controlling PWM). Therefore, the warning signal S4 can trigger the warning motion generated by the warning indicator 1a to strengthen. Taking the said warning light as the example of the warning indicator 1a, when the predicted time to collision of the approaching object with respect to the vehicle 1 becomes shorter, the lightness of the warning light becomes greater, the flashing frequency become faster, the comparison of light colors becomes stronger, or the colors of light become different (such as green/yellow/red) for identification of the urgency degree. Alternatively, taking the buzzer as the example, when the time to collision of the approaching object with respect to the vehicle 1 becomes shorter, the sound of the buzzer becomes louder.

The radar detection device 20 comprises a land change assistance (LCA) mode, which can increase the warning degree under a high collision risk coefficient according to the direction indicator signal of the CAN, the helm angle signal generated by the steering wheel and the aforementioned time to collision. For example, at the moment of the direction indicator signal being imputed, the warning indicator 1a outputs a red light or a high frequency flashing representing a risky situation.

Accordingly, the static object in the present invention includes not only the ground surface (road), but also objects such as road railings, trees, electric poles that cannot move. The moving object in the present invention includes not only the vehicles moving on the ground surface, but also objects such as motorcycles, pedestrians, or animals that can move. The approaching object in the present invention indicates the moving object which is relatively approaching the vehicle 1. For example, when a vehicle (or motorcycle) enters the detection area Z from the rear of the vehicle 1 and approaches the vehicle 1, the vehicle (or motorcycle) is deemed as the approaching object.

In the embodiment, the central processing module 21 further comprises a movement determination switch unit 215, which has a low distance resolution mode and a high distance resolution mode. The movement determination switch unit 215 can identifies the movement direction of the vehicle 1. When the movement determination switch unit 215 identifies that the vehicle 1 is moving forward, the signal sending and receiving module 22 operates in the low distance resolution mode; when the vehicle 1 is identified as moving backward, the signal sending and receiving module 22 operates in the high distance resolution mode.

Regarding the movement determination switch unit 215, the distance resolution is the index of the ability of the radar system identifying two targets at a certain distance. In other words, it represents the smallest distance required for differentiating two targets. In the embodiment, the low distance resolution mode has a distance resolution ranging from 30 to 60 centimeters; the distance resolution mode has a distance resolution ranging from 5 to 30 centimeters. Also, in a possible embodiment, the movement determination switch unit 215 changes the signal bandwidth of the signal sending and receiving module 22 to switch the low distance resolution mode and the high distance resolution mode. For example, at an initial frequency of 77 GHz, when the signal bandwidth is 4 GHz, the distance resolution of the signal sending and receiving module 22 is about 3.75 cm; when the signal bandwidth is 2 GHz, the distance resolution of the signal sending and receiving module 22 is about 7.5 cm; when the signal bandwidth is 1 GHz, the distance resolution of the signal sending and receiving module 22 is about 15 cm; when the signal bandwidth is 600 MHz, the distance resolution of the signal sending and receiving module 22 is about 25 cm. Therefore, the movement determination switch unit 215 changes the signal bandwidth of the signal sending and receiving module 22 to switch the low distance resolution mode and the high distance resolution mode for adjusting the distance resolution.

When the movement determination switch unit 215 of the present invention identifies that the vehicle 1 is moving forward, the movement determination switch unit 215 switches the signal sending and receiving module 22 to operate in the low distance resolution mode, so as to apply the blind spot detection (BSD) for detecting vehicles or other objects approaching from the read side of the vehicle 1. When the movement determination switch unit 215 identifies that the vehicle 1 is reversing, the movement determination switch unit 215 switches the signal sending and receiving module 22 to operate in the high distance resolution mode, so as to serve as a reverse radar for detecting the obstacles in the rear of the vehicle during the reversing of the vehicle 1. Accordingly, the movement determination switch unit 215 of the present invention automatically detects the moving direction of the vehicle 1, such that the signal sending and receiving module 22 is automatically switched to operate in the low distance resolution mode or the high distance resolution mode. Thus, the signal sending and receiving module 22 has different modal values for application in blind spot detection or providing a reverse radar detection function.

Based on the fact that the distance resolution of the low distance resolution mode ranges from 30 to 60 centimeters, and the distance resolution of the high distance resolution mode ranges from 5 to 30 centimeters, the detection of railing, electric pole, or small obstacle can be detected with a more precise resolution, thereby preventing error or abnormal detection issues. When the present invention is applied for blind spot detection, the obstacles to be detected are larger objects such as other vehicles. Therefore, instead of precise resolution, a larger detection range is needed, which requires a farther radar refection detection ability for providing a sufficient time for driver reaction. Thus, the present invention serves as both the blind spot detector and a reverse radar with the signal sending and receiving module 22 which is applicable in the low distance resolution mode and the high distance resolution mode, thereby fulfilling different demands in different moving statuses of the vehicle.

Further, the half power beam width (HPBM) of the sending and receiving module 22 on the H-plane ranges from 130 to 180 degrees, and the half power beam width of the sending and receiving module 22 on the E-plane ranges from 35 to 90 degrees.

It is noted that the blind spot detection and reversing radar detection shall have different reaction to the reflected vertical signal. For example, objects such as a metal manhole cover on the ground or a ditch cover will produce strong reflection signal. However, in blind spot detection and reversing radar detection, such objects will not cause any influence. As for higher level objects such as a flowerpot, stair, or animal like cat or dog, during blind spot detection, the reflection signals of those objects will be considered as objects passing near the vehicle which cause no effects on movement safety. However, during reversing radar detection, those reflection signals may influence the vehicle safety and shall therefore be considered. Therefore, referring to FIG. 7, the central processing module 21 of the present invention further comprises a vertical signal determination unit 216, which divides the second signal S2 received by the signal sending and receiving module 22 in the vertical direction into a lower layer signal, a middle layer signal, and a higher layer signal. Therein, in the high distance resolution mode, the signal sending and receiving module 22 ignores the lower layer signal. In the low distance resolution mode, the signal sending and receiving module 22 ignores the lower layer signal and the middle layer signal. Furthermore, the lower layer signal is the reflection signal from 0 to 10 centimeters above the ground surface, the middle layer signal is the reflection signal from 10 to 30 centimeters above the ground surface, and the higher layer signal is the reflection signal from 30 centimeters above the ground surface.

Referring to FIG. 7, in a possible embodiment, the central processing module 21 is electrically connected with the controller area network (CAN) 1b for acquiring the gear signal of the vehicle 1, so as to detect the moving direction status of the vehicle 1.

In another possible embodiment, the velocity calculation unit 211 calculates the relative velocity of the object in the detection area Z with respect to the vehicle 1, so as to identify if the object is a static object or a moving object, and identify the moving direction and the velocity of the vehicle 1 based on the relative moving direction and relative velocity of the vehicle 1 and the static object, providing a determination basis for the movement determination switch unit 215. Notably, the “speed” refers to the traveling route passed through by the object in a unit time, which does not include the direction thereof; the “velocity”, which is different from the “speed”, describes the physical quantity of the speed and direction of the object movement. In the embodiment, when the speed of the vehicle is higher than a threshold value, the movement determination switch unit 215 directly determines that the vehicle 1 is in a status of moving forward, so as to control the signal sending and receiving module 22 to be switched to the low distance resolution mode. For further explanation, the threshold value can be set as 40 kilometers. Since a driver seldom reverses the vehicle 1 at 40 km/hour, the possible moving status of the vehicle 1 can be determined accordingly by referring to status of the reflection signal and the threshold value.

Also, referring to FIG. 9, the objects in the detection area Z are mostly static objects such as the ground surface, divisional island or railings, and other moving objects (such as those approaching or leaving the vehicle 1) just account for a small portion. Therefore, most of the reflection signals having the same velocity detected by the signal sending and receiving module 22 can be determined as static objects, and other second signals S2 having different velocities are determined as moving objects. Accordingly, by cooperating the modal value calculation unit 213 and the velocity calculation unit 211, the modal value calculation unit 213 determines the objects having the same velocity in the most amount in the detection area Z as static objects. Furthermore, when in a traffic jam or when the vehicle velocity is slower, other vehicles in the rear may be too close to the vehicle 1, so that most of the second signals S2 in the detection area Z of the signal sending and receiving module 22 are reflected by the vehicle in the rear of the vehicle 1, causing an error of determination. However, because the wheels in movement are revolving fast, so that the reflection signal produced by the wheels can be received by the radar for identification. Therefore, the second signals S2 of a target vehicle having the wheels signal features or the second signals S2 from above the wheels can be screened and excluded first, so as to ensure the correctness of the speed calculation result of the modal value calculation unit 213. Thus, the central processing module 21 of the present invention further comprises an interference elimination unit 217, which excludes the second signals S2 of a vehicle having a wheel reflection feature. When the vehicle speed is lower than the threshold value, the interference elimination unit 217 preferentially detects and excludes the vehicle reflection signal, and the velocity calculation unit 211 subsequently identifies the moving direction of the vehicle, based on which the movement determination switch unit 215 carries out the determination process and controls the signal sending and receiving module 22 to be switched to the low distance resolution mode or the high distance resolution mode.

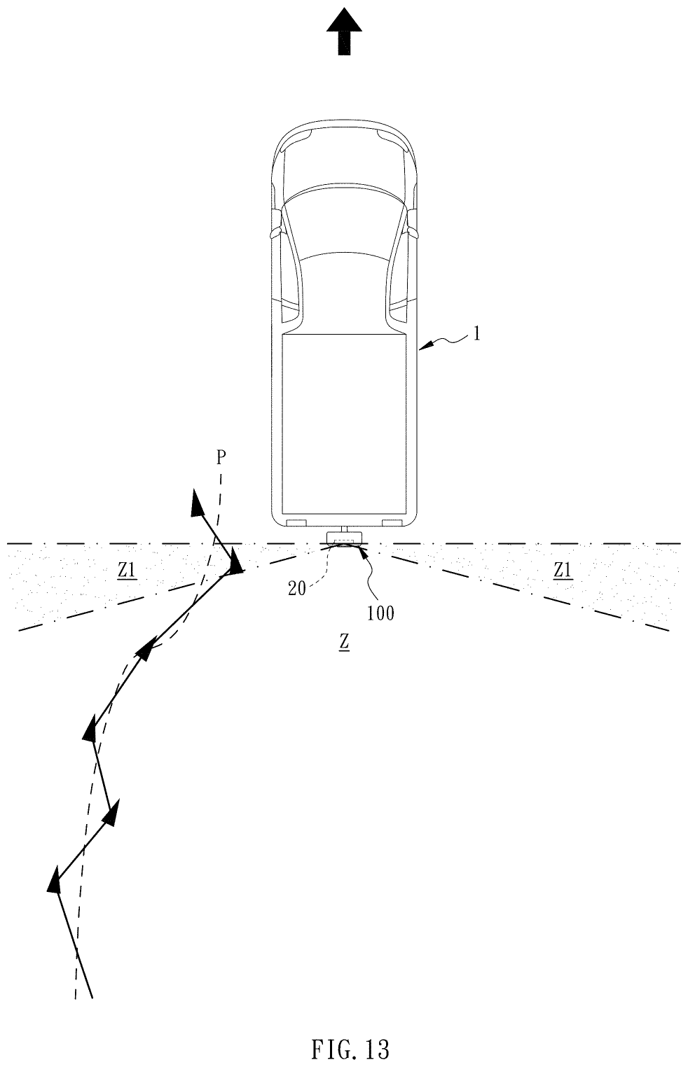

In a possible embodiment, the present invention further comprises a path prediction module 23 electrically connected with the central processing module 21. Referring to FIG. 13, because the detection angle of the signal sending and receiving module 22 is smaller than 180 degrees, at least a detection blind area Z1 exists on the left and the right side of the signal sending and receiving module 22. The path prediction module 23 acquires the velocity and direction information of the approaching object according to the reflection signal of the signal sending and receiving module 22, wherein the positions of the aforementioned reflected sample points are accumulated to form an approximate line (as a solid line) for detecting the relative movement direction, speed and angle, thereby predicting the moving path P of the approaching object. When the path prediction module 23 calculates that the approaching object entering the detection blind area Z1, the warning can still be provided until the approaching object leaves the detection blind area Z1. Therefore, erroneous judgement of the driver due to the blind area of the signal sending and receiving module 22 is effectively prevented.

According to the description above, the features of the present invention are clear.

The pedal 100 of the present invention comprises the installation space 17 for receiving the radar device 20. The pedal body 10 applies the interlaced straight ribs 15 and arc ribs 16 and the reinforcement space 18 thereby formed having reinforcement structure therebetween in increase the structural strength of the pedal 100. Therefore, the pedal 100 has better weight bearing capability, and provides protection to the radar device 20 in the installation space, thereby ensuring the effective operation of the radar device 20.

When the vehicle 1 is not towing objects, the pedal 100 is installed on the rear of the vehicle 1 for passenger to enter or leave the vehicle 1. Besides, the radar device 20 in the pedal 100 provides the vehicle 1 with blind spot detection and reversing detection functions, so as to prevent collision accidents without the need of complicated wiring structure.

The reinforcement pillar 19 and connection ribs 191 form a radiation structure similar to the shape of the sun. Also, each reinforcement pillar 19 and connection rib 191 extend toward the pedaling face 13 to be connected with the pedaling face 13 by one end. Therefore, the reinforcement pillar 19 is disposed in an approximate parallel arrangement with the direction imposing force of a person stepping on the pedal body 10, so as to directly bear the pedaling force, thereby providing a greater weight bearing capability and protecting the radar device 20 in the installation space 17.

The installation space 17 has three sides corresponding to the reinforcement spaces 18, so that the installation space 17 is surrounded by more reinforcement spaces 18, thereby providing a higher structural protection to the radar device 20 disposed in the installation space 17.

The radar device 20 detects the relative velocity of the object in the detection area Z with respect to the vehicle 1 for identifying the static objects and moving objects, thereby identifying the relative velocity of the vehicle 1 with respect to the static object as the movement speed of the vehicle, so as to achieve the blind spot detection function according to the vehicle speed information. The pedal 100, provided with speed detection function itself, does not need to acquire the vehicle speed signal of the vehicle 1. Therefore, the pedal 100 does not need to be connected with the CAN of the central controlling system of the vehicle 1 to operate. The installation is simple, and the cost is reduced.

When the present invention is applied for reversing detection in the high distance resolution mode, the detection of railing, electric pole, or small obstacle can be detected with a more precise resolution, thereby preventing error or abnormal detection issues. When the present invention is applied for blind spot detection, the obstacles to be detected are larger objects such as other vehicles. Therefore, instead of precise resolution, a larger detection range is needed, which requires a farther radar refection detection ability for providing a sufficient time for driver reaction. Thus, when serving as the blind spot detector or the reverse radar, the signal sending and receiving module 22 can operate in the low distance resolution mode or the high distance resolution mode, thereby fulfilling different demands in different moving statuses of the vehicle.

The path prediction module 23 acquires the speed and direction information of the approaching object through the reflection signal by use of the signal sending and receiving module 22, so as to predict the movement path of the approaching object. Therefore, even if the approaching object enters the detection blind area, the warning will still be generated.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pedal with anti-collision detection function installed on a rear of a vehicle, the pedal comprising:
a pedal body comprising a front lateral side and a rear lateral side that are spaced and arranged along a longitudinal axis of the pedal body, the front lateral side and the rear lateral side being disposed on different planes, with a pedaling face connected between the front lateral side and the rear lateral side; a first connection face and a second connection face extending from two sides of the pedaling face to be connected between the front lateral side and the rear lateral side, forming a recess on the pedal body; an insertion segment extending from the rear lateral side; in the recess of the pedal body, a plurality of arc ribs being arranged from the rear lateral side toward the front lateral side at intervals, and a plurality of straight ribs extending from the rear lateral side toward the front lateral side; an installation space being formed on an inner side of the front lateral side toward the rear lateral side; a plurality of reinforcement spaces being disposed between the arc ribs and the straight ribs, and the reinforcement spaces being arranged in adjacent to the installation space, and each reinforcement space containing a reinforcement structure; and
a radar device disposed in the installation space.

2. The pedal of claim 1, wherein each reinforcement space comprises an inner wall; each reinforcement structure comprises a reinforcement pillar and a plurality of connection ribs arranged in a radiation arrangement connected between the reinforcement pillar and the inner wall; each reinforcement pillar and the connection ribs extend toward the pedaling face to be connected with an inner side of the pedaling face.

3. The pedal of claim 2, wherein the reinforcement pillar is formed in a hollow column shape; the installation space and at least one of the reinforcement spaces are arranged on the longitudinal axis, and two of the reinforcement spaces arranged on both sides of the longitudinal axis, respectively.

4. The pedal of claim 3, wherein the installation space comprises a pair of vertically formed block portions; the radar device is disposed in a place between the two block portions and an inner lateral of a back of the front lateral side.

5. The pedal of claim 4, wherein the installation space corresponds to at least three reinforcement spaces, and each reinforcement space contains six connection ribs therein.

6. The pedal of claim 1, wherein the pedal body comprises a wire recess in communication with the installation space; the installation space comprises a first opening, and the rear lateral side comprises a second opening; the wire recess passes through one of the reinforcement spaces, such that the wire recess has one end connected to the first opening, and another end of the wire recess is connected to the second opening.

7. The pedal of claim 6, further comprising a spring clamp for clamping a wire which is electrically connected with the radar device on the arc ribs or the straight ribs.

8. The pedal of claim 1, wherein the pedal body comprises a wire recess in communication with the installation space; the installation space comprises a first opening, and the rear lateral side comprises a second opening; the wire recess passes through one of the reinforcement spaces along one of the arc ribs, such that the wire recess has one end connected to the first opening, and another end of the wire recess is connected to the second opening.

9. The pedal of claim 8, wherein further comprising a spring clamp for clamping a wire which is electrically connected with the radar device on the arc ribs or the straight ribs.

10. The pedal of claim 1, wherein the radar device comprises a central processing module and a signal sending and receiving module; the signal sending and receiving module sends a first signal toward a detection area in rear of the vehicle, so as to acquire a second signal which is reflected by an object in the detection area; the central processing module is electrically connected with the signal sending and receiving module to receive the second signal; the central processing module comprises a velocity calculation unit and an approaching object detection unit; the velocity calculation unit calculates a relative velocity of objects in the detection area with respect to the vehicle for identifying if the object is a static object or a moving object, and the approaching object detection unit identifies the approaching object in the detection area according to the second signal for carrying out a blind spot detection operation.

11. The pedal of claim 10, wherein the central processing module further comprises a modal value calculation unit electrically connected with the velocity calculation unit; the modal value calculation unit determines the objects having a same velocity in a most amount in the detection area as the static objects.

12. The pedal of claim 1, wherein the radar device comprises a central processing module and a signal sending and receiving module; the central processing module comprises a movement determination switch unit; the movement determination switch has a low distance resolution mode and a high distance resolution mode; the signal sending and receiving module is electrically connected with the central processing module; the movement determination switch unit identifies a movement direction of the vehicle; when the movement determination switch unit identifies that the vehicle is moving forward, the signal sending and receiving module operates in the low distance resolution mode; when the vehicle is identified as moving backward, the signal sending and receiving module operates in the high distance resolution mode.

13. The pedal of claim 12, wherein the central processing module further comprises a vertical signal determination unit, which divides the second signal received by the signal sending and receiving module in a vertical direction into a lower layer signal, a middle layer signal, and a higher layer signal.

14. The pedal of claim 13, wherein in the high distance resolution mode, the signal sending and receiving module ignores the lower layer signal; in the low distance resolution mode, the signal sending and receiving module ignores the lower layer signal and the middle layer signal; the central processing module is electrically connected with a controller area network of the vehicle for acquiring a gear signal of the vehicle, so as to detect a moving direction status of the vehicle.

15. The pedal of claim 14, wherein the central processing module comprises a velocity calculation unit; the signal sending and receiving module sends a first signal toward a detection area in rear of the vehicle, so as to acquire a second signal which is reflected by an object in the detection area; the velocity calculation unit calculates a relative velocity of an object in the detection area with respect to the vehicle for identifying if the object is a static object or a moving object, thereby identifying a movement direction and the relative velocity of the vehicle with respect to the static object as the movement direction and speed of the vehicle as a determination basis for the movement determination switch unit.

16. The pedal of claim 15, wherein the central processing module comprises a modal value calculation unit electrically connected with the velocity calculation unit; the modal value calculation unit determines the objects having a same velocity in a most amount in the detection area as the static objects.

17. The pedal of claim 16, wherein when the speed of the vehicle is higher than a threshold value, the movement determination switch unit directly determines that the vehicle is moving forward, such that the signal sending the receiving module is switched to the low distance resolution mode.

18. The pedal of claim 17, wherein the central processing module further comprises an interference elimination unit, which excludes the second signal of a vehicle having a wheel reflection feature; when the vehicle speed is lower than a threshold value, the interference elimination unit preferentially detects and excludes the corresponding second signal of that vehicle, and the velocity calculation unit subsequently identifies the moving direction of that vehicle, based on which the movement determination switch unit carries out determination process and controls the signal sending and receiving module to be switched to the low distance resolution mode or the high distance resolution mode.

19. The pedal of claim 18, further comprising a path prediction module electrically connected with the central processing module; the path prediction module acquires the velocity and direction information of the approaching object according to the second signal of the signal sending and receiving module, so as to predict a moving path of the approaching object.

20. A pedal with radar installation space installed on a rear of a vehicle, the pedal comprising:
a pedal body comprising a front lateral side and a rear lateral side that are spaced and arranged along a longitudinal axis of the pedal body, the front lateral side and the rear lateral side being disposed on different planes, with a pedaling face connected between the front lateral side and the rear lateral side; a first connection face and a second connection face extending from two sides of the pedaling face to be connected between the front lateral side and the rear lateral side, respectively, forming a recess on the pedal body; an insertion segment extending from the rear lateral side; in the recess of the pedal body, a plurality of arc ribs being arranged from the rear lateral side toward the front lateral side at intervals, and a plurality of straight ribs extending from the rear lateral side toward the front lateral side; an installation space being formed on an inner side of the front lateral side toward the rear lateral side; a plurality of reinforcement spaces being disposed between the arc ribs and the straight ribs, and each reinforcement space containing a reinforcement structure.
